(19) United States
(12) Patent Application Publication
(10) Pub. No.: US 2012/0288660 A1
(43) Pub. Date: Nov. 15, 2012

(54) FILM LAMINATE FOR A TEAR-OPEN PACKAGE

(76) Inventors: Darius MASEIKER, Diepholz (DE); Jochen BRAUER, Lohne (DE)

(21) Appl. No.: 13/469,114

(22) Filed: May 11, 2012

(30) Foreign Application Priority Data
May 12, 2011 (EP) 11165914.0

(51) Int. Cl. B65D 65/28; B32B 38/04; C09J 7/02; B29C 35/08

(52) U.S. Cl. 428/43; 264/400; 156/272.8; 156/253

(57) ABSTRACT

A laminate for a tear-open package has an inner heat-sealable polymer film and an outer laser-cuttable polymer film laminated thereto, respectively forming a cover layer and a seal layer. The outer film is formed with at least one linearly extending laser score groove or scoring extending transversely at least partially through a thickness of the outer film. The inner film is formed along and in alignment with the laser scoring with a perforation line comprised of a row of cuts spaced along the scoring and separated by webs extending across the scoring. The cuts extend transversely at least partially though a thickness of the inner film.

### FIELD OF THE INVENTION

The present invention relates to a film laminate. More particularly this invention concerns such a laminate provided with a tear line for use in a tear-open package.

### BACKGROUND OF THE INVENTION

A typical such laminate used in a tear-to-open package has a sealing layer of heat-sealable polymer film on the inside of the package and a cover layer forming an outside surface of the package, this layer being composed of a polymer film that can be cut by a laser beam and that is provided with at least one laser scoring. Within the scope of the invention, “laser scoring” refers to the linear removal of material through the action of heat generated by a laser beam, which removal can function as a weakening line to allow the laminate or the package formed therefrom to be torn open. The laser scoring can have a pattern that is either straight or arcuately curved.

A film laminate for a tear-open package that includes the above-described features is disclosed in U.S. 2007/0284032. The laser scoring is provided in a section of the laminate that has been pretested by hot embossing. An embossing created by linear hot-embossing and the laser scoring generated by a laser beam coincide and together form a weakening line to enable a package composed of the laminate to be torn open.

DE 100 41 020 relates to a film that includes a weakening line created by a laser beam. The weakening line is composed of a scoring created by removing material such that package material remains in place continuously in the region of the weakening line. The printed specification does not provide information on the film or on the film material.

EP 1 094 013 relates to a film where a polymer layer of the film is prepunched along a weakening line. The weakening line is a perforation line composed of webs and cuts. A plurality of parameters must be strictly adhered to in order to is ensure that the weakening line functions properly. There is thus a requirement that the prepunched layer outside the weakening line have a tear resistance of greater than 0.3 daN, whereas the non-prepunched layer must have a tear resistance of less than 0.07 daN. A tear resistance is required outside the weakening line that is at least double the tear resistance of the weakening line.

Finally, U.S. 2008/0272182 discloses a protective wrapping for, inter alia, cold cuts, which wrapping includes a perforation line enabling it to be torn open. One aspect emphasized here is that the spacing of the perforation holes as well as their size are critically important to the functioning of the weakening line, and the spacing of the holes must be selected carefully. Premature tearing open can occur along the perforation line if the spacing is short—especially if pressure is applied from outside. Simple clean tearing open in the direction determined by the perforation line is no longer possible, or is possible only in response to considerable pulling force, if the spacing of the perforation holes is too large.

In the case of very tough composite laminates that include, for example, a cover layer of polyester and a sealing layer of polyethylene, the problem of tearing the laminate along a weakening line has not yet been solved in a satisfactory manner. A weakening line provided in the form of a perforation line appears ill-suited for a tough film laminate. The laminate stretches, then tears apart in uncontrolled fashion, or cannot is even be torn apart. If the selected webs of the perforation line are too short, there is a danger that the laminate web will tear apart even as soon as packages are folded or produced. If the composite laminates are provided only with a weakening line in the form of laser scoring, the laminates can be torn open only by applying considerable force, and therefore the tearing-open response of laser-treated weakening lines is also unsatisfactory.

### OBJECTS OF THE INVENTION

It is therefore an object of the present invention to provide an improved film laminate for a tear-open package.

Another object is the provision of such an improved film laminate for a tear-open package that overcomes the above-given disadvantages, in particular that can be torn open along the weakening line easily and with controlled propagation of the tear. At the same time, it should also be possible to employ very tough composite films.

A further object is to provide an improved method of making such a laminate.

### SUMMARY OF THE INVENTION

A laminate for a tear-open package. The laminate has according to the invention an inner heat-sealable polymer film and an outer laser-cuttable polymer film laminated thereto, respectively forming a cover layer and a seal layer. The outer film is formed with at least one linearly extending laser score groove or scoring extending transversely at least partially through a thickness of the outer film. The inner film is formed along and in alignment with the laser scoring with a perforation line comprised of a row of cuts spaced along the scoring and separated by webs extending across the scoring. The cuts extend transversely at least partially though a thickness of the inner film.

When the laser groove or scoring is made by a laser beam in the cover layer of the laminate, a large part of the thickness of the cover layer is removed in the area of the laser scoring. At the same time, a slight embrittlement occurs in the remaining laminate material, in particular also in the adjoining sealing layer. The embrittlement of the preferably polyolefin sealing layer is not in fact sufficient to allow the laminate to tear open easily. In surprising fashion, however, the combination according to the invention of a laser scoring and a perforation line aligned with this scoring does nevertheless result in a weakening line that can be torn open by a defined opening force both uniformly and with a defined tear propagation.

The cover layer can be composed, in particular, of polyethylene terephthalate (PET) or polybutylene terephthalate (PBT). In addition, the cover layer can be an oriented polyamide (OPA), an oriented polypropylene (OPP), or a biaxially oriented polypropylene (BOPP). The above-mentioned materials have good strength and can be readily printed with good printing quality. The use of a polyolefin cover layer should also not be excluded. What must be considered, however, is that polyolefins typically absorb laser radiation only poorly and the desired cutting effect will be lacking. If polyolefin is used as the cover layer, use of a polyolefin is recommended that contains laser-absorptive substances as an additive or admixed substance. Laser-absorptive substances are substances that absorb the radiation in a wavelength between 9.3 μm and 11.5 μm, then convert them to heat energy. These include mixed silicates, for example kaolinite, numerous inorganic substances, such as, for example mica, Mg silicates, kieselguhr, inorganic pigments, and also a few polymer substances, such as, for example high-molecular-weight polyethylene glycol, polysaccharides, polycarbonate, or polyethylene terephthalate. The sealing layer of the laminate is preferably always composed of a polyethylene.

A polymer intermediate layer can be provided between the cover layer and the sealing layer, which intermediate layer can be metallized on the side facing the sealing layer, thereby creating a gas/vapor barrier in the laminate. The intermediate layer is preferably composed of a metallized polyester film. The laser scoring preferably terminates within the intermediate layer at or immediately adjacent the metallized surface of the intermediate layer.

The cover layer of the laminate can also have at least two adjacent laser scorings with the perforation line extending in line with and along a first laser scoring of this arrangement and the sealing layer remaining mechanically intact below a second laser scoring of this arrangement. The laser scorings are provided adjacent and parallel to each other with close spacing. The spacing is advantageously less than 2 mm, a spacing of between 0.5 mm and 1 mm being preferred. The second laser scoring that is not combined with cuts of a perforation line creates an intercept line that guides the tear if it departs from the weakening line when the package is torn open.

Another object of the invention is a method comprising the step of first laminating together by coextrusion or by adhesive bonding an inner heat-sealable polymer film and an outer laser-cuttable polymer film. Then a laser is used to form in the outer film a linear laser score or groove extending transversely at least partially through the thickness of the outer film. Then the inner film is formed along and in alignment with the laser scoring with a perforation line comprised of a row of cuts spaced along the scoring and separated by webs extending across the scoring, the cuts extending transversely at least partially though a thickness of the inner film.

Making a laser scoring with a laser beam causes a large part of the cover layer to be removed in the region of the laser scoring, and the result is a slight embrittlement of the remaining thickness of the sealing layer. When the laminate is subsequently perforated in the laser-treated line, only the material of the sealing layer and the polymer remnants of the cover layer have to be severed.

The perforation can be generated by cutting or punching, and is preferably made from the outer surface of the sealing layer. The cuts or openings extend inward and terminate at or immediately adjacent the floor of the laser score groove.

The film laminate can have a polymer intermediate layer between the cover layer and the sealing layer, the intermediate layer having a metallized surface facing the sealing layer. A laser scoring is made by a laser beam in the cover layer, extends into the intermediate layer, and ends at or immediately adjacent the metallized surface of the intermediate layer. The perforation is then created by cuts that are formed from the outside of the sealing layer and extend to the metallized surface of the intermediate layer, or even penetrate the metallized layer if a vapor barrier is not needed.

### BRIEF DESCRIPTION OF THE DRAWING

The above and other objects, features, and advantages will become more readily apparent from the following description, reference being made to the accompanying drawing in which:

FIG. 1 is a highly enlarged view from outside, not to scale, of a portion of a film laminate having a weakening line according to the invention;

FIG. 2 is a section taken on plane II of FIG. 1 through the laminate in the region of the weakening line; and

FIG. 3 is a view like FIG. 1 but showing a variant of the invention.

### DETAILED DESCRIPTION

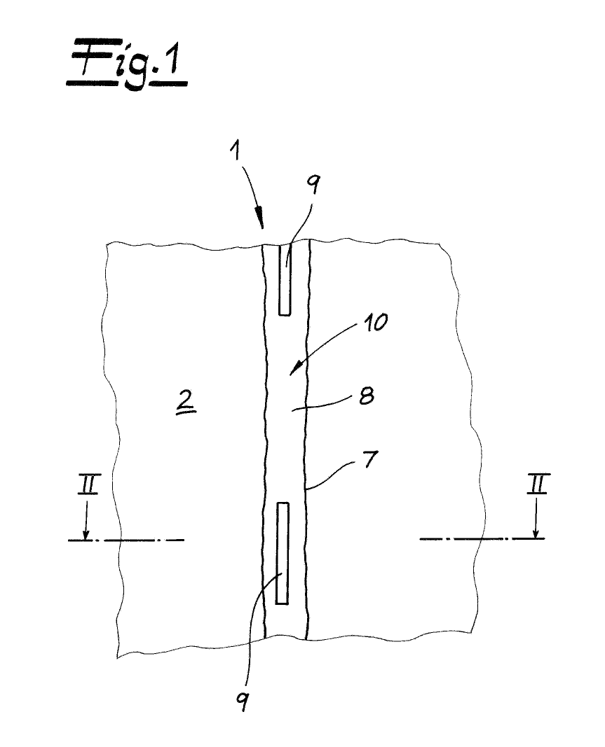

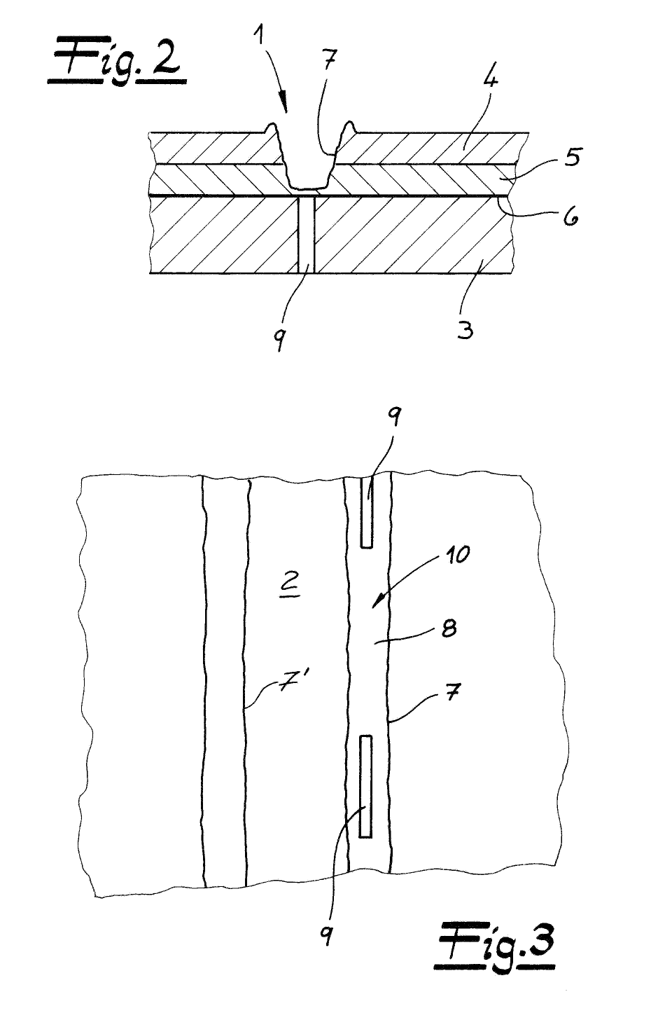

As seen in FIGS. 1 and 2 a film laminate 2 is formed with a tear or weakening line 1 for use in making a tear-open package. The laminate 2 has a sealing layer 3 composed of a heat-sealable polymer film intended to form the inside of the package, a polymer cover film 4 for the outside of the package, as well as a polymer intermediate film 5 between the cover film 4 and the sealing layer 3, which intermediate layer 5 is metallized at 6 on its side facing the sealing layer 3. The sealing layer 3 is composed, in particular, of polyethylene film. The cover layer 4 on the outside of the package is composed of a polymer film, in particular of a polyester film that can be cut by a laser beam. The intermediate layer 5 is also composed of a polyester film and has on its side facing the sealing layer 3 the metallized surface or foil 6 formed for example by vapor deposition. The multilayer laminate 2 can be produced by coextrusion or by adhesive bonding of the film layers 3, 4, and 5.

The laminate 2 in the drawing has a highly enlarged weakening line 1. This is formed by a scored groove 7 created by a laser beam that cuts completely through the cover layer 4 and at least partially through the intermediate layer 5. The laser scoring 7 is also called a laser scoring line, and is created by the removal of material in response to the thermal action of a laser beam. A perforation line 10 formed by webs 8 crossing the line 1 and cuts 9 between the webs 8 extends along and is aligned with the laser scoring 7 such that the cuts 9 of the perforation line 10 at least partially penetrate the sealing layer 3. The cuts 9 of the perforation line extend from the outer surface of the sealing layer 3 inward and terminate at or in front of the floor of the laser scoring. Each cut 9 is elongated and extends longitudinally in the weakening line 1 and the webs 8 are of a longitudinal length slightly greater than that of the cuts 9.

The combination of laser scoring 7 and aligned perforation line 10 together create the weakening line 1 along which the laminate 2, or a package composed of this laminate, can be torn open easily and uniformly with defined propagation of the tear.

When the weakening line 1 is produced, the laser scoring 7 is generated first in the cover layer 4 by a laser beam. During lasing, the cover layer 4 and a large portion of the thickness of the intermediate layer 5 are removed. At the same time, a slight embrittlement of the sealing layer 3 composed of polyethylene occurs in the region of the laser scoring 7. When the laminate is subsequently perforated along the lased line, only polyester remnants must be cut through in the region of the laser scoring 7. The polyethylene layer 3 in combination with the cuts 9 of the perforation line 10 results in the weakening line 1 that has surprisingly good tear-open properties.

In a variant illustrated in FIG. 3, the cover layer 4 of the laminate 2 has at least two adjacent and parallel laser scorings 7, 7′. The perforation line 10 extends along and is aligned with the first laser scoring 7 of this arrangement. The sealing layer 3 remains mechanically intact underneath the second laser scoring 7′. Laser scorings 7 and 7′ of the arrangement illustrated in FIG. 3 are provided closely adjacent to each other with a transverse spacing of less than 2 mm. The laser scoring 7′ creates an intercept line that guides the tear if it departs from the first weakening line composed of the laser scoring 7 and the perforation 10

We claim:

1. A laminate for a tear-open package, the laminate comprising an inner heat-sealable polymer film and an outer laser-cuttable polymer film laminated thereto, the outer film being formed with at least one linearly extending laser scoring extending transversely at least partially through a thickness of the outer film, the inner film being formed along and in alignment with the laser scoring with a perforation line comprised of a row of cuts spaced along the scoring and separated by webs extending across the scoring, the cuts extending transversely at least partially though a thickness of the inner film.

2. The laminate defined in claim 1, wherein the cuts of the perforation line extend from an outer surface of the inner film inward and terminate at or adjacent a floor of the laser scoring.

3. The laminate defined in claim 1, wherein the outer film is composed of a polyester, an oriented polyamide, an oriented polypropylene, or a biaxially oriented polypropylene.

4. The laminate defined in claim 1, wherein the inner film is composed of a polyethylene.

5. The laminate defined in claim 1, further comprising:
a polymer intermediate film between the outer film and the inner film, the intermediate film being metallized on a surface facing the inner film.

6. The laminate defined in claim 5, wherein the intermediate film is a metallized polyester.

7. The laminate defined in claim 5, wherein the laser scoring terminates within the intermediate film at or immediately adjacent the metallized surface of the intermediate film.

8. The laminate defined in claim 1, wherein the outer film has adjacent the first-mentioned laser scoring a second laser scoring, the perforation line extending along the first laser scoring and the inner film remaining mechanically intact below the second laser scoring.

9. The laminate defined in claim 8, wherein the first and second laser scorings are transversely spaced by less than 2 mm.

10. A method of making a film laminate comprising the steps of:
laminating together by coextrusion or by adhesive bonding an inner heat-sealable polymer film and an outer laser-cuttable polymer film;
forming with a laser in the outer film a linear laser score extending transversely at least partially through the outer film; and
forming in the inner film along and in alignment with the laser scoring with a perforation line comprised of a row of cuts spaced along the scoring and separated by webs extending across the scoring, the cuts extending transversely at least partially though a thickness of the inner film.

11. The laminate-making method defined in claim 10, wherein the perforation line is made by cutting or punching.

12. The laminate-making method defined in claim 11, wherein the cutting or punching is done from an outer surface of the inner film.

13. The laminate-making method defined in claim 10, further comprising the step of:
laminating between the inner and outer films a polymer intermediate film having a metallized surface facing the inner film, the laser scoring extending through the outer film and into the intermediate film and terminates at or immediately adjacent the metallized surface of the intermediate film.

14. The laminate-making method defined in claim 10 wherein the cuts extend from an outer surface of the inner film inward to immediately adjacent the metallized surface of the intermediate film.
